(19) United States
(12) Patent Application Publication
(10) Pub. No.: US 2024/0112199 A1
(43) Pub. Date: Apr. 4, 2024

(54) CONFIGURING INFRASTRUCTURE OF A NETWORK SERVICE BASED ON IMPACT TO AN ENVIRONMENTAL CONCERN

(71) Applicant: Uber Technologies, Inc., San Francisco, CA (US)

(72) Inventors: Michael Sudakovitch, San Francisco, CA (US); Sergey Nazarov, San Francisco, CA (US)

(21) Appl. No.: 17/957,892

(22) Filed: Sep. 30, 2022

(51) Int. Cl. G06Q 30/018

(52) U.S. Cl. CPC G06Q 30/018

(57) ABSTRACT

A network system that analyzes the infrastructure of a network service to determine alternative configurations that reduce the impact of the network service to an environmental concern.

### TECHNICAL FIELD

Examples described herein relate to configuring infrastructure of a network service based on impact to an environmental concern.

### BACKGROUND

Companies continuously develop network services to provide functionality of various types. For example, network services are used to provide the underlying functionality for applications running on mobile devices (“apps”), software-as-a-service (“SaaS”) products, utility services (e.g., deployment of updates to OS or applications) and various other functionality. By way of illustration, a food delivery app can deploy numerous network services that combine to enable a user to request and receive a food delivery order. A food delivery app can deploy, for example, network services that communicate with the user's mobile app to determine its location, provide menus and information for the user to make selections, and process payment for the user. Network services may also run to provide a delivery order to a restaurant, to assign the delivery order to a driver, and to monitor the driver's location for pickup and delivery. Before a user opens a food delivery app, network services may be running to implement functions such as onboarding drivers, enabling food providers to create menus, determining the location of drivers, monitoring the location and status of drivers, updating food offerings based on provider input or market conditions, managing user information and numerous other functions.

The network services that are deployed can also include microservices, which are programs that perform discrete steps or operations used in a workflow. In many cases, numerous such network services operate transparently and in combination to perform specific tasks of a workflow.

Typically, companies develop workflows to manage the implementation of a function or task, where the workflows define steps performed by one or more network services. Once initiated, workflows can run independently of other workflows. Each workflow can utilize one or more network services to implement the tasks of the workflow. In some architectures, network services (e.g., microservices) can be shared between workflows. As such, depending on design and configuration, a network service can vary in size (e.g., number of tasks performed), frequency of use (e.g., heavy versus light), program configurations, and complexity.

The growing prevalence of network services has coincided with the growth of data centers and cloud computing platforms, which typically host the network services. Typically, developers choose platforms or providers which manage data centers where individual network services are deployed. Developers often choose such platforms and providers based on considerations such as performance, cost and availability.

### BRIEF DESCRIPTION OF THE DRAWINGS

FIG. 1 illustrates a network system for configuring infrastructure of a network service, according to one or more embodiments.

FIG. 2A illustrates an example method for provisioning infrastructure of a network service to reduce detrimental impact to an environmental concern, according to one or more embodiments.

FIG. 2B illustrates an example method for monitoring and updating the configurations of infrastructure provisioned for a network service, according to one or more embodiments.

FIG. 3 illustrates an example output interface which can be generated by a network system, according to one or more embodiments.

FIG. 4 illustrates a computer system on which one or more embodiments can be implemented.

### DETAILED DESCRIPTION

Embodiments include a network system that analyzes the infrastructure of a network service to determine alternative configurations that reduce the impact of the network service to an environmental concern, such as climate change or carbon emissions. As described with various examples, a network system can identify technical changes to the infrastructure of the service, to improve the functioning of the network service, specifically by enabling reduction to the attributable impact of the network service with regards to an environmental concern.

In examples, the network system operates to reduce the attributable impact of a network service to carbon emissions. While specific examples are recited in context of carbon emissions and climate change, embodiments as described can be implemented to address other types of environmental concerns, such as energy sustainability and environmental pollution.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

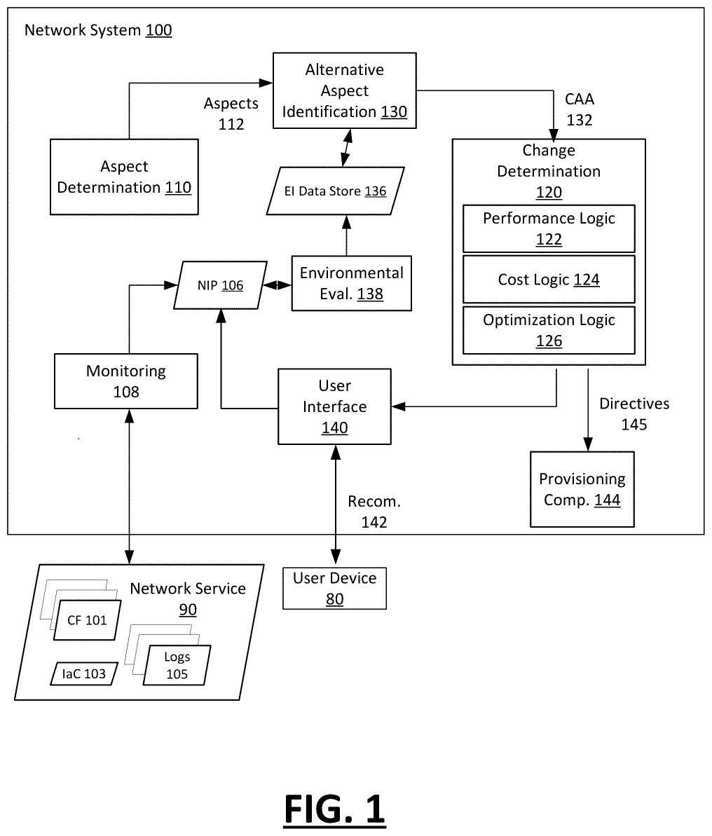

FIG. 1 illustrates a network system for configuring infrastructure of a network service, according to one or more embodiments. In particular, embodiments provide for a network system that determines alternative configurations for the infrastructure, where the alternative configurations are selected based on an objective of reducing an attributable impact of the network service to an environmental concern. In some examples, the alternative configurations are selected based on an objective of reducing the amount of carbon emissions (e.g., the ‘carbon footprint’) of the network service.

In some examples, the network system 100 operates to generate a set of recommendations for a user of the network system 100, where the recommendations identify alternative configurations for provisioning infrastructure for providing the network service. As an addition or variation, the network system 100 operates to implement alternative configurations for provisioning the infrastructure of a network service, to optimize the network service based on an objective of, for example, reducing the amount of carbon emissions that are attributable to the network service. Further, the network system 100 can implement the alternative configurations responsive to input provided by a user that receives a corresponding recommendation. As another variation, the network system 100 can automatically implement alternative configurations, based on an objective of reducing the amount of carbon emissions that is attributable to the network service.

In examples, the network system 100 operates to identify alternative configurations for how the network service can be provisioned, before deployment, in order to improve the impact that the network service has on the environment once it is deployed. For example, the network system 100 can identify and recommend reconfigurations for a planned infrastructure of a network service. As an addition or variation, the network system 100 can operate to identify alternative configurations to the provisioned infrastructure of a deployed network service. For example, the network system 100 can identify and recommend reconfigurations for an existing infrastructure of a network service that is in use, in order to improve the impact of the provisioned infrastructure on an environmental concern.

With reference to an example of FIG. 1, the network system 100 includes aspect determination component 110, change determination component 120, alternative aspect determination component 130, and user interface component 140. While examples describe the components of the network system 100 as being separate, examples can provide for the components (or functionality described therewith) to be integrated. Thus, for example, functionality described with one component can be performed in whole or in part by another.

Existing Determination of Environmental-Significant Aspects

The aspect determination component 110 includes processes that identify environmental-significant aspects of an existing or planned infrastructure for implementing a network service. In examples, each environmental-significant aspect (also referred to as “aspect”) corresponds to a technical characteristic of the infrastructure configuration that is deemed to have a quantifiable impact on an environmental consideration (e.g., amount of carbon emissions attributable to the network service). By way of example, each aspect can correspond to one of (i) a geographic location of hardware resources deployed with the infrastructure; (ii) a type of hardware or software resources used by the network service; and/or (iii) program or logic components for implementing the network service, such as program jobs, workflow, and programming language.

The aspect determination component 110 can analyze different types of informational resources for a network service 90 to determine the aspects of an infrastructure. The aspects of the network service 90 can be determined either before or after the network service is deployed. For example, the aspects of the network service 90 can be determined before the infrastructure is provisioned. Alternatively, the aspects of the network service 90 can be determined one or more times after the network service is deployed. In the latter case, the resources of the network service 90 can be analyzed to determine if configuration of the infrastructure can be optimized or otherwise improved with regards to the impact of the network service on an environmental concern. The information resources can include, for example, (i) configuration files 101 generated by or in connection with implementation of the network service, (ii) infrastructure code 103, corresponding to programmatic instructions which can implement configurations for provisioning infrastructure to provide the network service, and (iii) log files 105, generated in connection with implementation and use of the network service. Still further, in some examples, the aspect determination component 110 can receive user input to identify aspects of the infrastructure provisioning.

In examples, a user operates computing device 80 to interact with one or more interface components (represented by user interface component 140), and to establish a network infrastructure profile 106 for a network service. The network infrastructure profile 106 can include data that identifies the aspects of the existing or planned infrastructure. In examples, a user can correspond to an individual that has a role in provisioning infrastructure for implementing a network service. The user can interact with the network system 100 to provide various types of input that define or provide specification and details of an existing or planned network service. The user can, for example, specify configuration files 101, infrastructure code (IaC) 103, log files 105, or manual input to specify information about the infrastructure. The IaC 103 can refer to programmatic code that is typically used by network service operators to deploy their network services on a cloud computing platform. Further, in some implementations, the manual input can be provided through, for example, a guided user interface that prompts the user for particular inputs that relate to aspects of the infrastructure. In some examples, the aspect determination component 110 employs text analysis logic 104, which can, for example, parse and analyze configuration files 101, IaC 103, and log files 105 to detect and record aspects of the existing or planned infrastructure. In variations, the aspect determination component 110 can utilize programmatic agents represented in part by the monitoring component 108, which the user can deploy to collect log and configuration files of an existing network service. Depending on implementation, the network infrastructure profile 106 can maintain raw data (e.g., recent log and configuration files) and/or processed data (e.g., data representing predetermined aspects of the network service 90).

Determination of Environmental-Impact of Existing or Planned Configuration

The aspect determination component 110 determines a set of aspects 112 for an existing or planned infrastructure based on the information resources and user input. Further, infrastructure profile 106 can record the set of aspects 112, in association with an identifier of the network service. In some examples, the set of aspects 112 can be determined in connection with the network service being provisioned. As an addition or variation, the aspect determination component 110 includes processes that repeatedly scan the information resources of an existing infrastructure to determine and update aspects of the network service. The aspect determination component 110 can, for example, utilize monitoring agents 108 to access the information resources (configuration files 101, IaC 103, log files 105) used or generated by the network service while the network service is deployed.

For each identified aspect, the aspect determination component 110 can determine one or more environmental metrics that are indicative of the detrimental impact to the environmental concern that is attributable to the network service, as a result of the infrastructure being configured to include that aspect. As described, the environmental metrics for individual aspects can be maintained with one or more data stores that reference predetermined environmental metrics with specific aspects (see AEI data store 136). Still further, in some examples, the environmental metric for individual aspects of the network service 90 can be determined using, for example, processes to evaluate resources and usage of the network service 90. For example, processes described below with environmental usage component 138 can be used to evaluate one or more aspects of the network service 90.

Based on the environmental metrics associated with aspects of network service 90, the aspect determination component 110 can determine an environmental metric for the network service 90, where the environmental metric quantifies or is otherwise indicative of the detrimental impact of the network service to an environmental concern. By way of example, the aspect determination component 110 can determine an amount of carbon emissions that are attributable to the network service 90. The environmental metric for the aspects of the network service, as well as for the network service as a whole, can be maintained as part of the network infrastructure profile 106 of the network service 90.

Determination of Candidate Alternative Environmental-Significant Aspects

The alternative aspect determination component 130 includes processes that match aspects 112 identified by the aspect determination component 110 to candidate alternative aspects 132, based on a determination that the candidate alternative aspects 132 are likely to improve an attributable impact of the network service 90 to an environmental concern. For example, the environmental metric can correspond to a carbon emission metric that is indicative of an amount of carbon emissions that are attributable to a particular aspect of the network service 90. In such case, examples provide that the alternative aspect 132 can be selected to improve the impact of the network service 90 on the environmental concern of carbon emissions, specifically by reducing carbon emissions that are attributable to the network service 90. The alternative aspect determination component 120 can compare the environmental metrics of alternative aspects with the environmental metrics of the aspects of the existing infrastructure, to determine the candidate alternative set of aspects 132. As an addition or variation, the alternative aspect determination component 120 can simulate or otherwise determine an environmental metric of the network as a whole, with implementation of one or more alternative aspects of the candidate set 132. In this way, the alternative aspect determination component 120 can identify alternative aspects for configuring the infrastructure of the network service, in a manner that improves the impact of the network service with respect to an environmental concern.

Accordingly, in some examples, the alternative aspect determination component 130 determines a candidate set of alternative aspects 132, where each candidate alternative aspect 132 is associated with or otherwise determined to have the most desirable environmental metric. For example, the determined alternative aspect (or aspects) may be associated with a metric that indicates the particular aspect has the lowest amount of attributable carbon emissions amongst aspects of the same type. In variations, the alternative aspect determination component 130 determines a candidate set of alternative aspects 132, where each candidate alternative aspect is associated or otherwise determined to have an environmental metric that is an improvement over the existing aspect. For example, the alternative aspect determination component 130 can identify a candidate set of alternative aspects 132 that are each associated with a carbon emission metric that indicates the particular aspect, when utilized in the configuration of the infrastructure of the network service 90, is an improvement over the existing aspect and its carbon emission metric. Still further, the alternative aspect determination component 130 can identify, as candidates, those aspects which meet one or more threshold criteria, such as those alternative aspects that are deemed to meet or improve upon the existing aspect by a threshold amount. For example, the alternative aspect determination component 130 can identify a candidate set of alternative aspects 132 that are each associated with a carbon emission metric that indicates the particular aspect is an improvement over the existing aspect and its carbon metric by a threshold amount (e.g., the alternative aspect improves has a carbon emission metric that is a 10% improvement over the carbon emission metric of the existing aspect).

In determining the candidate set of alternative aspects 132, the alternative aspect determination component 130 can access one or more aspect/environmental-impact (“AEI”) data stores 136 that reference or correlate aspects of particular types with one or more environmental metrics that relate to an environmental concern. The AEI data store 136 can correspond to, for example, a list, table, database or combination of such data structures. In examples, the data store 136 can associate geographic locations where hardware resources can be located with a carbon emission metric (or other environmental metric) that identifies or is indicative of an amount of carbon emissions that may be attributable to that aspect in connection with implementation of the network service.

To further the example, the set of existing aspects 112 can identify one or multiple geographic locations where hardware resources for implementing network services can be implemented, where each geographic location is also associated with an environmental metric. The alternative aspect determination component 130 can identify, as a candidate alternative aspect, each alternative geographic location where the environmental metric is more desirable (e.g., deemed to have a lesser impact on the environment if used).

Accordingly, the AEI data store 136 can correlate aspects of multiple different types with one or more environmental metrics (e.g., carbon emission metric, sustainability metric, etc.). For example, the AEI data store 136 can associate one or more environmental metrics with (i) each available geographic location of a collection of possible geographic locations, (ii) each type of hardware or software resource of a collection of possible resources, (iii) each type of programming language of a set of multiple possible types of programming languages, and/or (iv) other predefined types of environmental-significant aspects of respective types.

In examples, the environmental metric(s) associated with the various aspects that are maintained with data store 136 can be obtained from (i) third-party information resources, (ii) measurements and calculations determined through resources of the network system 100, and/or (iii) inferences made from third-party information and/or measurements and calculations. In examples, an environmental evaluation component 138 can be implemented to measure or otherwise determine one or more environmental metrics for specific aspects. For example, the environmental evaluation component 138 can utilize energy consumption information for a particular data center, along with region specific information that indicates sustainability (e.g., percentage of power on region grid that originates from renewable energy), as well as site-specific information (e.g., whether data center uses solar panels, age or modernization of data center, etc.) to estimate one or more environmental metrics (e.g., carbon emission metric) that are to be associated with a specific geographic region where hardware resources may be located. With regards to hardware resources, the environmental metrics can be obtained from, for example, manufacturer's ratings and specifications, as well as power consumption, energy efficiency or rating. With respect to software components and programming language, the environmental metrics may be based on, for example, the amount of run-time data that is used by the software component, as well as the amount of processing, data and/or memory resources used by the software component.

Ongoing Monitoring and Evaluation

According to some examples, the network system 100 can analyze a network service that has been deployed to determine improvements which can be made to its configuration, for purpose of reducing the detrimental environmental impact of the network service to an environmental concern. As an addition or variation, the environmental evaluation component 138 utilizes monitoring processes, as represented by monitoring component 108, to monitor and ingest the configuration files 101, IaC 103 and/or log files 105 of an existing (or deployed) network service 90, in order to determine input parameters for calculating the environmental metrics used by specific aspects of the network service. The environmental evaluation component 138 and monitoring component 108 parse the configuration files 101, IaC 103 and/or log files 105 to identify program-implemented, environmental-significant aspects, such as (i) the number of operations or jobs executed by hardware or software resources of the network service 90, (ii) the amount of data used by the jobs or software resources, and/or (iii) the frequency or times when the jobs are executed for the network service 90. Still further, the environmental evaluation component 138 can determine power usage signals from hardware resources and/or management resources (e.g., such as provided by a data center), in connection with implementation of the network service 90. In some examples, the environmental evaluation component 138 utilizes or implements metric determination logic 142 to estimate, or determine indicators for, one or more environmental parameters. The environmental evaluation component 138 may generate one or more outputs that associate an existing aspect of a deployed network service with one or more environmental metrics. The alternative aspect determination component 130 can update the infrastructure profile 106 of a given network service based on the outputs of the environmental evaluation component 138. As an addition or variation, the environmental evaluation component 138 can update or create correlations between environmental-significant aspects and their respective environmental metrics, where such correlations are maintained by the AEI data store 136.

Change Determinations to Infrastructure

The change determination 120 includes processes that make a determination as to whether implementing a change to a planned or existing infrastructure of the network service is warranted or desirable, based on one or more of the candidate alternative aspects 132. As described further, in some examples, the determination can be made to determine a change to an aspect of a network service with the greatest beneficial impact on an environmental consideration. In variations, the determination can be made to determine a change to an aspect of a network service, where the change is deemed optimal in regards to an objective that weights environmental impact, performance, cost and/or other considerations.

In examples, the change determination component compares the environmental metric for aspects of network service 90 to environmental metrics of corresponding aspects. As an addition or variation, the change determination component 120 includes performance logic 122 to determine the effect that each potential change will likely have on performance metrics of the network service. For example, the performance logic 122 can include data and code for determining network latency as between the geographic regions. The change determination component 120 can determine whether changing the geographic location of one or more hardware resources will detrimentally impact the latency of the network service, based on considerations such as (i) the geographic distance between where the hardware resource is located and the location where the network service is to be used, and (ii) the bandwidth of the alternative geographic location. As another example, a geographic location may be associated with a downtime metric, based on historical down-time observed with either the region of the geographic location or the facility. The performance logic 122 can be implemented to compare such performance metrics between an existing location and an alternative location, as well as between alternative locations, in order to determine whether, for example, performance associated with an existing location will deteriorate if the geographic location of the corresponding hardware resource is moved to an alternative location. Through such comparisons, or series of comparisons, the performance logic 122 can associate a performance metric with the existing location, and each alternative location that is deemed as a possible replacement (as may be identified in the set of alternative aspects 132).

With respect to hardware and software resources, the change determination component 120 can implement the performance logic 122 to select, from the candidate alternative set 132, one or more alternative types of hardware or software resources that can be used in place of existing hardware or software resources of the infrastructure. The performance logic 122 can access, for example, manufacturer-provided specifications that identify performance attributes of existing hardware/software resources as well as those of alternative hardware/software resources provided by the alternative candidate set 132. Alternatively, the AEO data store 136 may associate performance metrics with hardware/software resources that are used in the deployment of network services. The performance logic 122 can further compare the performance attributes of the existing and alternative aspects, based on data provided by the manufacture-provided specifications. In some examples, the performance logic 122 can include processes that simulate performance of jobs and workflow of the network service through use of existing hardware/software resources as compared to hardware/software combinations of the candidate set 132.

Still further, in examples, the change determination component 120 implements cost logic that determines a cost associated with implementing a change to the infrastructure that is used by the network service. For example, the AEI data store 136 can associate a unit of cost with each determined aspect of the network service 90, and the change determination component 120 can implement the cost logic 124 to calculate, based on respective unit costs, a comparative cost for implementing the network service using resources that are provided at different geographic locations. In this way, the change determination component 120 can implement the cost logic 124 to compare a cost for deploying the network service using the existing set of aspects, with a cost for deploying the network service using alternative aspects.

In examples in which the network system 100 is used to implement changes to a deployed network service 90, the cost comparison that is determined by the change determination component 120 can also estimate cost associated with implementing a given change. For example, a change in geographic location, hardware resources, or software resources can result in downtime of the network service 90. Likewise, a change in geographic location of hardware resources can result in increased latency, which can also be associated with a cost. In this regard, the cost can be quantified or based on performance metrics, such as downtime or latency, or other metric that quantifies deterioration or quality of network service 90.

Additionally, in examples, the change determination component 120 can implement optimization logic 126 that optimizes selection (or non-selection) of a change to the infrastructure of a network service 90, based on one or more considerations that include benefit to an environmental consideration. By way of example, the change determination component 120 can select one or more changes to the infrastructure based on different optimization criteria. For example, the optimization logic 126 can identify one or more changes that are suitable for cost or performance, and optimal for impact to environmental consideration (e.g., minimize an amount of carbon emission that is attributable to the network service 90). The suitability determination can be based on, for example, the determined change resulting in a cost and/or performance difference that is within a predefined threshold of the existing configuration. The determination that a change is optimal for impact to environmental consideration can correspond to a change that is selected as meeting the suitability criteria and also having the greatest desired impact to an environmental metric (e.g., amount of carbon emissions). In this way, the selected change does not have an unacceptable negative impact on performance or cost.

As still another example, the change determination component 120 can associate weighted parameters to values representing performance, cost and environmental impact amongst a set of alternative infrastructure configurations, where each infrastructure configuration includes a different combination of aspects for implementing the network service. The optimization logic 126 can, for example, implement a cost function that aggregates (e.g., weighted sum) the weighted values of each infrastructure configuration, and uses the aggregated values to select the particular configuration that is deemed to be optimal.

In examples, change determination component 120 also includes logic to determine feasibility or viability of implementing the change. For example, the change determination component 120 can identify when the network service utilizes specific hardware (e.g., persistent data store) that is only available in a specific location. The change determination component 120 can recognize that the cost and environmental impact of moving persistent storage (e.g., populated database) would eliminate the benefit of implementing the change. In such case, the change determination component 120 can determine the change to not be feasible (or viable), so that it is not identified as a recommendation or acted upon.

Still further, the change determination component 120 can identify when changes are feasible at a particular time (e.g., planning stage). For example, the change determination component 120 can identify that when a particular network service is building a database, the time for implementing a change to move the physical location of the database is at the planning stage. Thus, the change determination component 120 can identify changes to implement when the network service is in the planning stage that would not otherwise be identified once the network service is deployed.

Actionable Recommendations

In examples, the change determination component 120 generates a set of recommendations 142 for the user interface component 140. Each recommendation 142 provided by the change determination component 120 can identify a change to an existing or planned infrastructure, where the change is deemed to improve an environmental consideration (e.g., amount of carbon emissions attributable to the network service). Each identified change can correspond to at least one change in an identified aspect of the existing or planned infrastructure, in place of an alternative aspect. In some implementations, each recommendation can also include information that quantifies or indicates a degree or amount of beneficial change to the environmental condition of interest. For example, each recommendation 142 can identify an amount of carbon emissions reduction or savings which is likely to result from implementation of the corresponding change. Additional information can also be provided by the individual recommendations 142. For example, the impact of implementing a recommended change on performance or cost can also be represented with the recommendation.

In examples, the user interface component 140 enables the user to act on individual recommendations generated by the change determination component 120. For example, the user can accept a recommendation. In response, a provisioning component 144 can implement configuration commands or files (e.g., an updated IaC 103) so that the updated configuration with the recommended change is implemented.

In examples, change determination component 120 generates one or more notifications that identify recommended changes for the user to implement. For example, a notification can be provided in the form of a ticket or other output that indicates changes which the user can initiate or implement to the configuration of the network service. The notification can also include information that quantifies or indicates a degree or amount of beneficial change to the environmental condition of interest (e.g., amount of reductions in carbon emissions, etc.). The user can respond to the notification by, for example, choosing to implement one or more recommended steps of the recommendation.

In variations, the change determination component 120 generates a set of directives 145, where the directives 145 identify changes that can be made to the configuration of the infrastructure in order to improve the attributable impact of the network service 90 to an environmental concern. For example, the directives 145 can identify an alternative geographic location for the hardware components that are used to implement the network service 90, in order to reduce a carbon footprint (e.g., how much carbon is generated as a result of the network service 90). The directives 145 can cause the provisioning component 144 to implement operations that change the configuration of the infrastructure. For example, the provisioning component 144 can implement operations to move a data center that is used by the network service 90, to an alternative data center in a different geographic location, based at least in part on a determination that the move will reduce the amount of carbon emissions which are attributable to the network service. To further the example, the provisioning component 144 can implement a series of operations or steps that transfer the location of the hardware resources for implementing the network service from the existing geographic location to the geographic location identified by directives 145. The operations or steps to transition the location of the hardware resources can include, for example, (i) generating or updating the IaC 103 for the network service 90, (ii) confirming that the transition to the new geographic location has occurred, and (iii) ceasing use of hardware resources at the prior location. In variations, the operations or steps to transition the location of hardware resources can be responsive to the user receiving and acting on one or more recommendations. For example, the recommendations can be communicated to users as actionable notifications that are responsive to user input to initiate a workflow where a planned or existing infrastructure is reconfigured.

Methodology

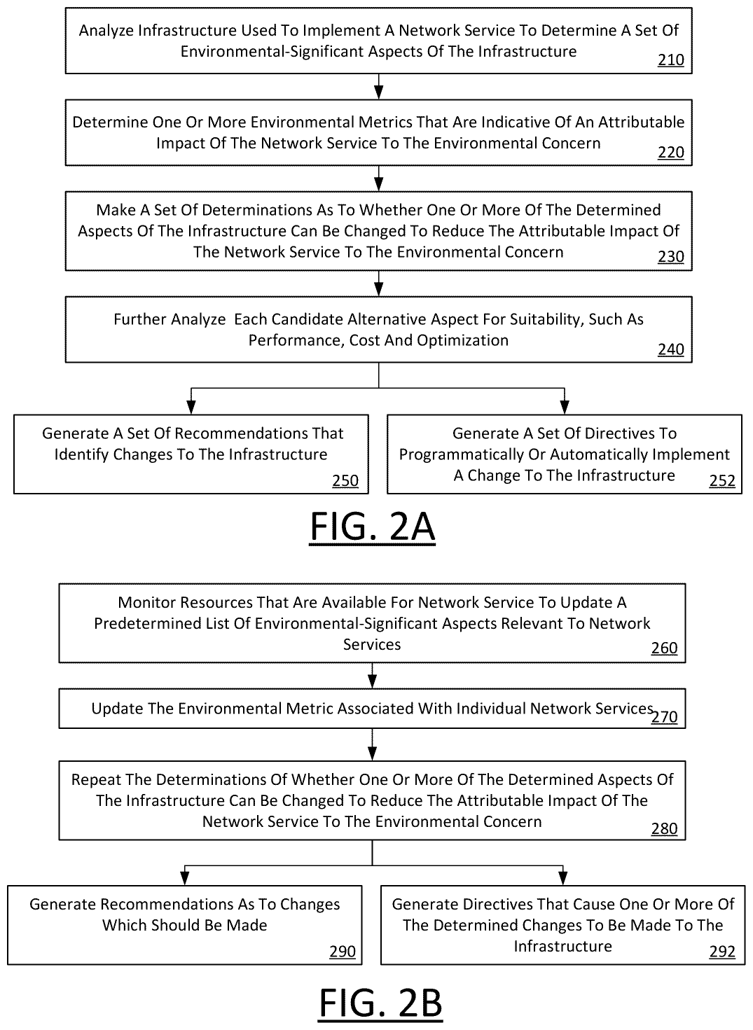

FIG. 2A illustrates an example method for provisioning infrastructure of a network service to reduce detrimental impact to an environmental concern, according to one or more embodiments. FIG. 2B illustrates an example method for monitoring and updating the configurations of a infrastructure provisioned for a network service, according to one or more embodiments. In describing examples of FIG. 2A and FIG. 2B, reference may be made to elements of FIG. 1 for purpose of illustrating suitable components and functionality for performing a step or sub-step being described.

With reference to FIG. 2A, in step 210, network system 100 analyzes infrastructure used to implement a network service to determine a set of environmental-significant aspects of the infrastructure. Each such aspect can correspond to a technical characteristic of the infrastructure. Further, each such aspect can be of a predetermined type, where the particular aspect can be substituted, replaced or otherwise changed to have a potentially significant and quantifiable difference on the attributable impact of the network service with regards to an environmental consideration (e.g., amount of carbon emissions attributable to the network service). In examples, the identified aspects can include (i) a geographic location of hardware resources deployed with the infrastructure; (ii) a type of hardware or software resources used by the network service; and/or (iii) program or logic components for implementing the network service, such as program jobs, workflow, and programming language.

In step 220, based on the determined aspects, the network system 100 determines one or more environmental metrics that are indicative of an attributable impact of the network service to the environmental concern. The network system 100 can, for example, determine one or more environmental metrics for each identified aspect of the network service, where each environmental metric relates directly or indirectly to an environmental concern. For example, the environmental metric can correspond to a score that is indicative of an amount or degree of attributable impact to an environmental concern. As another example, the environmental metric can correspond to a quantity (e.g., calculated amount), representing, for example, the attributable impact of using the aspect to an environmental concern. The network system 100 can quantify an impact of each aspect of the network service to the environmental concern. Further, the network system can quantify an impact of the network service to the environmental concern as a whole, based on the attributable impact by each of the identified aspects. By way of example, the network system 100 determines an amount of carbon emissions that are attributable to each of the identified aspects, as well as an amount of carbon emissions that are attributable to the network service as a whole, based on the contributions of the identified aspects.

In step 230, the network system 100 makes a set of determinations as to whether one or more of the determined aspects of the infrastructure can be changed to reduce the attributable impact of the network service to the environmental concern. For each identified aspect, the network system can determine one or more candidate alternative aspects that are deemed to have less impact on the environmental concern. For example, each determined aspect of the network service can be compared to a set of alternative aspects, to identify candidate aspects which have lesser impact to the environmental concern. Accordingly, the determinations can be based on (i) the environmental metric associated with the existing aspects, as compared to corresponding alternative aspects; and/or (ii) an environmental metric associated with the network service as a whole, when the infrastructure provisioning the network service is configured with the existing aspect, as compared with the corresponding alternative aspect.

In step 240, examples provide for network system 100 to further analyze each candidate alternative aspect for suitability, by determining (i) an impact of implementing the candidate alternative aspect on the performance of the network service, and/or (ii) an impact of implementing the candidate alternative aspect on the cost of providing the network service. In this way, the network system 100 can make determinations to change the infrastructure of the network service by implementing one or more candidate alternative aspects, based in part on the suitability of the candidate alternative aspects. As an addition or variation, the network system 100 can analyze each candidate alternative aspect for suitability, based on optimization determinations that take into account the environmental concern, performance and cost for using each candidate alternative aspect.

In step 250, based on the set of determinations, the network system 100 generates a set of recommendations that identify changes that can be made to the infrastructure of the network service, where each change identifies an aspect of the existing infrastructure which should be changed or replaced with a determined candidate alternative aspect. These one or more recommendations can be provided in a presentation or user interface for display (e.g., such as part of a visualization or tool for software development and deployment) to an end user, developer, or administrator responsible for configuring the infrastructure and/or providing the features of the network service. For example, some embodiments provide for the network system 100 to recommend changes to the infrastructure of a network service in order to reduce the carbon emissions that are attributable to the network service (e.g., reduce the carbon footprint of the network service).

As an addition or variation, in step 252, the network system 100 generates a set of directives that can programmatically, or automatically, implement a change to the infrastructure, such that an existing environmental-significant aspect is changed or replaced by another aspect that is determined to to reduce the attributable impact of the network service on the environmental concern. Thus, in some variations, the network system can implement changes to the infrastructure to reduce the carbon emissions or footprint of the network service.

With reference to FIG. 2B, embodiments further recognize that factors which can change the determinations of network system 100 can be dynamic. For example, with regards to the environmental concern of carbon emissions, embodiments recognize that new hardware resources routinely become available that operate more efficiently and/or are associated with a lesser carbon emission metric. To illustrate, a carbon emission metric that is attributable to a given geographic location (e.g., where a data center may be located) can fluctuate based on a variety of factors. For example, the power grid used with the data center can become overloaded because of weather (e.g., heat wave), reducing efficiency of the power plants that power the grid, which in turn decreases the energy sustainability of the region, resulting in a greater carbon footprint associated with the particular data center. As another case, the load on a network service can dramatically increase, resulting in more data storage and operations being executed. In such case, the difference in geographic locations with regards to carbon emissions attributable to the data center where the network service can become significant (e.g., exceed a threshold), such that a change to the geographic location of the data center is merited based on carbon emissions. Accordingly, determinations made by the network system 100 can be dynamic and made to update or change the configuration of a deployed network service. For example, a method such as described by FIG. 2A can be implemented to configure an infrastructure of a network service before it is deployed, or alternatively, to reconfigure a network service that is deployed in a manner that has or becomes sub-optimal as to an environmental concern. Subsequent to the network service being deployed utilizing a method such as described by FIG. 2A, a method such as described with FIG. 2B can be implemented to reconfigure the infrastructure in a manner that maintains or improves the impact of the network service on the environmental concern. For example, a method such as described with FIG. 2B can be implemented to tune the configuration of the infrastructure from time-to-time, such that the reconfiguration of the network service is robust and responsive to changes in infrastructure resources that are in use and/or available for use for the network service.

In step 260, network system 100 monitors resources that are available to network resources to update a predetermined list of environmental-significant aspects relevant to network services. The operations which network system 100 performs to monitor aspects can vary, based on, for example, the type of aspect. For the geographic location of hardware resources (e.g., data centers), the network system 100 can interface with, for example, information provided by a power grid operator at the location of the data center and/or a power meter readings at the data center. For example, the network system 100 can repeatedly make such updates by accessing resources from which an environmental metric can be determined. For example, the network system 100 can repeatedly monitor the power consumptions at various geographic locations where hardware resources (e.g., data centers) are available to implement network services. Based on changes detected to the power consumptions, the environmental metric associated with the associated metrics may be changed.

As another example, the network system 100 can also monitor the power usage profile of the hardware resources which are in use, to detect, for example, brown-out conditions which are markers of an overloaded grid. Based on power consumption readings and other factors (e.g., the energy sustainability rating of a region or location), the network system 100 can recalculate or estimate the one or more environmental metrics that are associated with known locations where hardware resources for hosting network services are located.

As another example, the network system 100 can monitor inventory of hardware resources at locations, to determine type of hardware resources (e.g., servers) that are available at the various locations. Each hardware resource may be pre-associated with specifications or metrics from which an associated environmental metric specific to an environmental concern (e.g., metric indicative of carbon emissions) can be estimated or calculated. Still further, the network system 100 can detect the availability or existing hardware resources at different locations. To determine these types of information, the network system may interface with information provided by facilities or providers (e.g., cloud-service providers). The predetermined list of known aspects can be updated to account for additional hardware components, such as newly acquired hardware components and/or hardware components that become available, as well as the calculated or estimated environmental metric for each hardware component.

In step 270, the network system 100 can update the environmental metric associated with individual network services. The update can be based on existing aspects of the network service. For example, the network system 100 can perform operations described with step 220 to determine or update environmental metrics that are indicative of an attributable impact of the network service to the environmental concern. As an addition or variation, the network system 100 can update the determined environmental metrics by monitoring implementation and use of the network service. The network system 100 can determine, for example, the number of times the network service is called or executed, the amount of data that is handled by the network service, and/or other indicators reflecting execution, use or load on the network service. The network system 100 can determine such information by, for example, scanning log files and data generated by the network service.

For individual network services, the network system 100 can, in step 280, repeat the determinations of whether one or more of the determined aspects of the infrastructure can be changed to reduce the attributable impact of the network service to the environmental concern. The determinations of step 280 can be performed using updated environmental metrics determined in steps 260 and 270, as described with step 230. In step 290, the network system 100 can generate recommendations as to changes which may be made, as described with step 250. As an addition or variation, in step 292, the network system 100 can generate directives that cause one or more of the determined changes to be made to the infrastructure of the network service, as described with step 252.

### Examples

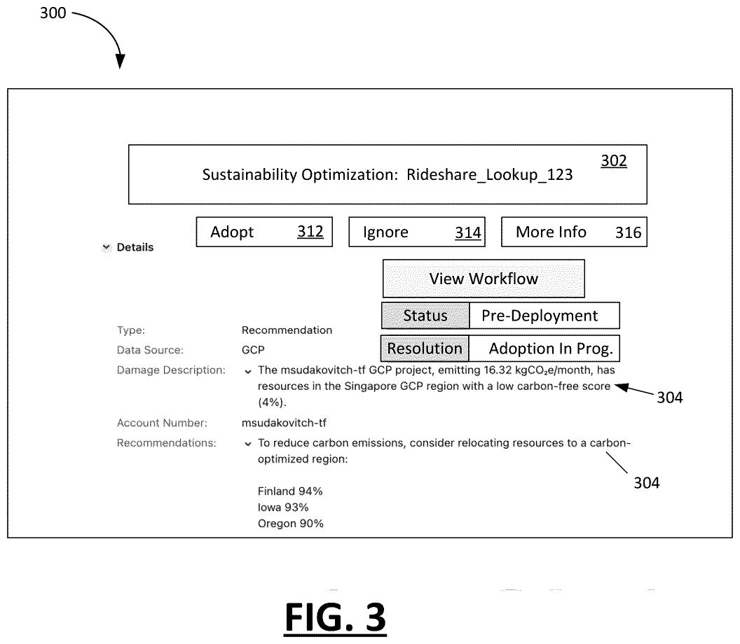

FIG. 3 illustrates an example output interface which can be generated by network system 100. In describing an example of FIG. 3, reference may be made to elements of FIG. 1 for illustrative purposes. An example of FIG. 3 is described in context of carbon emissions, where network system 100 identifies alternative configurations for a planned or existing infrastructure of a network service, in order to reduce the carbon generation (or carbon footprint) that is attributable to the network service. While an example of FIG. 3 is specific to the environmental concern of carbon emissions, variations can address alternative types of environmental concerns.

In an example illustrated by FIG. 3, the network system 100 generates an output interface 300, which may be generated on, for example, the user device 80. The output service 300 can be structured as a ticket that includes an identifier 312 for a corresponding network service, where the network service corresponds to, for example, a microservice, job, or application running in a network environment. The output interface 300 can indicate a status of the identified network service, such as whether the network service is planned (e.g., pre-deployment) or deployed.

In examples, the output interface 300 provides one or more information items 304, 306 to (i) identify an aspect of a planned or existing infrastructure that is the subject of the recommendation, and (ii) an action that can be taken to reconfigure the identified aspect in order to improve carbon emissions. In an example shown, the information item 304 identifies the physical location of a data center that is (or to be) used by the network service as the subject of the recommendation. The information item 304 can also provide information as to how the identified aspect impacts carbon emissions. For example, the information item 304 can generate an output that quantifies the amount of carbon emissions that is attributable to the identified aspect. The information item 306 displays the identified alternatives for the aspect identified by the information item 304. Further, the information item 306 can include information that indicates the specific manner in which the adoption of the recommendation will improve the impact of the network service on carbon emissions. For example, the information item 306 can quantify the reduction in carbon emissions resulting from adoption of the recommendation.

In an example of FIG. 3, the user can interact with input features 312, 314, 316 to adopt, ignore or receive more information about the recommendation. The user can interact with feature 312 to adopt the recommendation. As described with examples of FIG. 1, the network system 100 can then initiate and perform operations to implement the recommendation. The user can interact with feature 314 to ignore or dismiss the recommendation. Still further, the user can interact with the feature 316 to receive more information, such as information about additional alternatives to the recommendation.

In variations, the output interface 300 can be identified as a planned action which the network system 100 will take to adopt or implement a change identified by the information items 304, 306. Still further, in other variations, the network system 100 can be identified as a report, identifying actions taken to implement changes identified by the information items 304, 306.

The particular structure and format of the output interface 300 may vary, based on implementation. For example, in variations, output interface 300 can be displayed in list form where, for example, identified aspects of a network service are displayed as rows, with information items 304, 306 being provided in columnar fashion.

Hardware Description

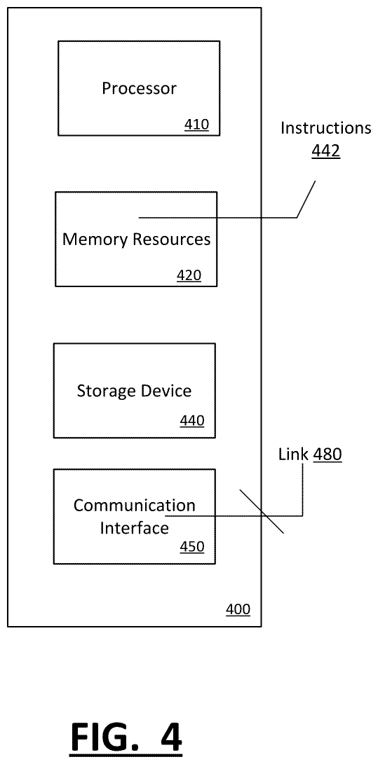

FIG. 4 illustrates a computer system on which one or more embodiments can be implemented. A computer system 400 can be implemented on, for example, a server or combination of servers. For example, the computer system 400 may be implemented as part of an example of FIG. 1. Likewise, the computer system 400 can implement a method such as described with an example of FIG. 2A and/or an example of FIG. 2B.

In one implementation, the computer system 400 includes processing resources 410, memory resources 420 (e.g., read-only memory (ROM) or random-access memory (RAM)), a storage device 430, and a communication interface 450. The computer system 400 includes at least one processor 410 for processing information stored in the main memory 420, such as provided by a random-access memory (RAM) or other dynamic storage device, for storing information and instructions which are executable by the processor 410. The main memory 420 also may be used for storing temporary variables or other intermediate information during execution of instructions to be executed by the processor 410. The computer system 400 may also include the memory resources 420 or other static storage device for storing static information and instructions for the processor 410. The storage device 430, such as a magnetic disk or optical disk, is provided for storing information and instructions.

The communication interface 450 enables the computer system 400 to communicate with one or more networks (e.g., cellular network) through use of the network link 480 (wireless or a wire). Using the network link 480, the computer system 400 can communicate with one or more computing devices, specialized devices and modules, and one or more servers. The executable instructions stored in the memory 420 can include instructions 442, to implement a network computing system such as described with an example of FIG. 1. The executable instructions stored in the memory 420 may also implement a method, such as described an example of FIG. 2A and/or an example of FIG. 2B.

As such, examples described herein are related to the use of the computer system 400 for implementing the techniques described herein. According to an aspect, techniques are performed by the computer system 400 in response to the processor 410 executing one or more sequences of one or more instructions contained in the memory 420. Such instructions may be read into the memory 420 from another machine-readable medium, such as the storage device 430. Execution of the sequences of instructions contained in the memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computing system comprising:
one or more processors;
a memory to store a set of instructions;
wherein the one or more processors execute the set of instructions to perform operations comprising:
analyzing infrastructure for implementing a network service to (i) determine a set of aspects of the infrastructure, and (ii) based on the set of aspects, determine one or more environmental metrics that are indicative of an attributable impact of the network service to an environmental concern;
making a set of determinations as to whether one or more aspects of the infrastructure can be changed to reduce the attributable impact of the network service to the environmental concern; and
based on the set of determinations, generating a recommendation that identifies a change to the infrastructure, to replace an aspect of the set of aspects with a corresponding aspect.

2. The network computing system of claim 1, wherein the operations include:
correlating each aspect of the infrastructure with a corresponding environmental metric, the attributable impact of the network service to the environmental concern being based at least in part on the corresponding environmental metric of each aspect.

3. The network computing system of claim 1, wherein the one or more metrics are indicative of an amount of carbon emissions generated by the infrastructure in providing the network service.

4. The network computing system of claim 3, wherein the operations further comprise:
determining one or more environmental metrics for an aspect of the infrastructure by measuring or calculating energy consumption associated with the aspect.

5. The network computing system of claim 1, wherein the operations includes:
for each aspect of the set of aspects, (i) determining an environmental metric that is indicative of the attributable impact of the aspect to the environmental concern; (ii) a corresponding alternative aspect and (ii) a corresponding environmental metric of the alternative aspect; and
wherein making the set of determinations includes, for each aspect of the set, making a determination to change an aspect of the set of aspects based on a comparison of the environmental metric of that aspect with the environmental aspect of the corresponding alternative aspect.

6. The network computing system of claim 5, wherein generating the set of recommendations includes identifying the corresponding alternative aspect, along with an indication that represents a reduction of detrimental impact attributable to the network service with regards to the environmental concern, resulting from implementing the infrastructure to include the alternative aspect.

7. The network computing system of claim 6, wherein a recommendation of the set includes an indication of a change to performance of the infrastructure once the corresponding alternative aspect of the recommendation is implemented.

8. The network computing system of claim 6, wherein generating the set of recommendations includes identifying the corresponding alternative aspect, along with each of (i) an indication of a reduction of the environmental concern resulting from implementing the infrastructure to include the corresponding alternative aspect, and (ii) an indication of the performance metric of the infrastructure once the alternative aspect is implemented.

9. The network computing system of claim 5, wherein making the determination to change individual aspects of the set of aspects includes determining that implementing the infrastructure to include the alternative aspect satisfies a performance criterion.

10. The network computing system of claim 5, wherein making the determination to change individual aspects of the set of aspects includes determining that implementing the infrastructure to include the alternative aspect satisfies a cost criterion.

11. The network computing system of claim 1, wherein the set of aspects of the infrastructure provisioned for the network service include at least one of (i) a type of hardware resource, (ii) a type of software resource, or (iii) a location of at least one of the hardware or software resource.

12. The network computing system of claim 1, wherein the set of aspects of the infrastructure provisioned for the network service include a job or workflow that is executed by the network architecture in connection with the network architecture providing the network service.

13. The network computing system of claim 1, wherein analyzing the infrastructure provisioned for the network service includes analyzing the infrastructure code.

14. The network computing system of claim 1, wherein analyzing the infrastructure provisioned for the network service includes performing textual analysis of one or more configuration files or usage logs generated by implementation of the network service.

15. The network computing system of claim 14, wherein analyzing infrastructure provisioned for implementing the network service includes monitoring usage information generated by implementation of the network service, and based on the usage information, and based in part on the usage information, making the set of determinations as to whether one or more aspects of the infrastructure can be changed.

16. The network computing system of claim 1, wherein the operations further comprise:
responsive to user input, implementing the change of the recommendation to the infrastructure provisioned for the network service.

17. A method for configuring infrastructure provisioned for a network service, the method being implemented by one or more processors and comprising:
analyzing a infrastructure provisioned for implementing a network service, to (i) determine a set of aspects of the infrastructure, and (ii) based on the set of aspects, determine one or more environmental metrics that are indicative of an attributable impact of the network service to an environmental concern;
making a set of determinations as to whether one or more aspects of the infrastructure can be changed to reduce the attributable impact of the network service to the environmental concern; and
based on the set of determinations, determining a change to the infrastructure, wherein the change replaces an aspect of the set of aspects with a corresponding aspect.

18. The method of claim 17, wherein the method further comprises:
implementing the change to the infrastructure.

19. The method of claim 18, wherein implementing the change to the infrastructure is performed automatically.

20. A non-transitory computer-readable medium that stores instructions, wherein the instructions, when executed by one or more processors of a network computing system, cause the network computing system to perform operations that include:
analyzing infrastructure provisioned for implementing a network service, to (i) determine a set of aspects of the infrastructure, and (ii) based on the set of aspects, determine one or more environmental metrics that are indicative of an attributable impact of the network service to an environmental concern;
making a set of determinations as to whether one or more aspects of the infrastructure can be changed to reduce the attributable impact of the network service to the environmental concern; and
based on the set of determinations, generating a recommendation that identifies a change to the infrastructure, to replace an aspect of the set of aspects with a corresponding aspect
